(19) United States
(12) Patent Application Publication
(10) Pub. No.: US 2011/0037445 A1
(43) Pub. Date: Feb. 17, 2011

(54) POWER CONTROL CIRCUIT FOR WIRE COMPENSATION AND COMPENSATION METHOD OF THE SAME

(75) Inventors: MING CHIANG TING, HSINCHU CITY (TW); CHUN-TE CHIANG, TAOYUAN COUNTY (TW); CHIN MING LIU, KAOHSIUNG CITY (TW); KER CHENG LIU, TAOYUAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: NIKO SEMICONDUCTOR CO., LTD., TAIPEI (TW)

(21) Appl. No.: 12/652,188

(22) Filed: Jan. 5, 2010

Related U.S. Application Data
(63) Continuation-in-part of application No. 12/585,265, filed on Sep. 10, 2009.

(30) Foreign Application Priority Data
Aug. 13, 2009 (TW) 98127315

(51) Int. Cl. G05F 1/10

(52) U.S. Cl. 323/234

(57) ABSTRACT

A power control circuit with wire compensation is provided. The power control circuit is applied in a power converter, which has an output coupled to a load through a power wire. The power control circuit has an adaptive sensing circuit and a controller. The adaptive sensing circuit is utilized for detecting an output voltage of the power converter and a current on the power wire and generating a feedback signal according to the output voltage and the current on the power wire. The controller is utilized for adjusting a level of the output voltage according to the feedback signal.

### REFERENCE TO RELATED APPLICATIONS

This Application is being filed as a continuation-in-part of patent application Ser. No. 12/585,265, filed 10 Sep. 2009, currently pending.

### BACKGROUND OF THE INVENTION

(1) Field of the Invention

This invention relates to a power control circuit, and more particularly relates to a power control circuit for wire compensation and a compensation method for compensating voltage drop on a power wire.

(2) Description of the Prior Art

FIG. 1 is a circuit diagram of a typical buck converter 10 which supplies electric power to a load 30 through a power wire 20. To stabilize the level of output voltage Vo, the buck converter 10 has a feedback circuit 12 and a controller 14 for performing feedback control on the output voltage Vo. The feedback circuit 12 is composed of two serially connected resistors and is utilized for detecting the level of the output voltage Vo for generating a feedback signal Vfb accordingly. The controller 14 receives the feedback signal Vfb and controls the conduction time of a switch according to the feedback signal Vfb so as to stabilize the level of the output voltage Vo.

Because of the parasitic resistors Rw on the power wire 20, a voltage drop Vw (V=2*Rw*Io) on the power wire 20 is unpreventable when electric power being supplied to the load 30. The level of the actual voltage Vo′ received by the load 30 would be lower than that of the predetermined output voltage Vo at the output of the buck converter 10.

In order to compensate the voltage drop on the power wire 20, as shown in FIG. 2, a typical method is to connect an additional detecting wire 22 to the load 30 to remotely sense the actual voltage Vo′ received by the load 30 for executing feedback control. As shown, the level at the power supply end of the load 30 is detected for executing feedback control, which is capable to compensate a half of the voltage drop on the power wire 20. However, this method needs at least one detecting wire 22 connected to the load 30, which may significantly increase the equipment cost especially when the converter 10 is far away from the load 30.

### SUMMARY OF THE INVENTION

Accordingly, it is a main object of the present invention to provide a power control circuit with the function of wire compensation, which is able to compensate the voltage drop on the power wire without the need of using the detecting wire as mentioned above to sense the actual voltage received by the load.

To achieve the above mentioned objects, a power control circuit for wire compensation is provided according to an embodiment of the present invention. The power control circuit is applied in a power converter, which has an output coupled to a load through a power wire. The power control circuit has an adaptive sensing circuit and a controller. The adaptive sensing circuit is utilized for detecting an output voltage of the power converter and a current on the power wire and generating a feedback signal according to the output voltage and the current on the power wire. The controller is utilized for adjusting a level of the output voltage according to the feedback signal.

As a preferred embodiment, the adaptive sensing circuit comprises a feedback circuit and a compensation resistor. The feedback circuit is utilized for detecting the output voltage of the power converter so as to generate the feedback signal. The compensation resistor is coupled to the power wire for detecting the current on the power wire and is also coupled to the feedback circuit for enhancing a level of the feedback signal accordingly.

A method for compensating a voltage drop on a power wire is also provided according to another embodiment of the present invention. The compensating method comprises the steps of: (a) providing the power wire, which is utilized for transmitting electric power from a power converter to a remote load; (b) selecting a compensation resistor according to a resistance of the power wire; (c) electrically connecting the compensation resistor to the power wire; and (d) electrically connecting the compensation resistor to a feedback circuit of the power converter to increase a level of a feedback signal outputted from the feedback circuit.

### BRIEF DESCRIPTION OF THE DRAWINGS

The present invention will now be specified with reference to its preferred embodiment illustrated in the drawings, in which:

FIG. 1 is a circuit diagram of a typical buck converter;

FIG. 2 is a circuit diagram of another typical buck converter describing a typical method for wire compensation;

FIG. 3 is a schematic view showing a power control circuit with the function of wire compensation in accordance with a preferred embodiment of the present invention;

FIGS. 4 and 4A are a schematic view showing a power control circuit in accordance with a preferred embodiment of the present invention applied in a buck power converter;

FIG. 5 is a schematic view showing a power control circuit in accordance with another preferred embodiment of the present invention applied in a buck power converter;

FIG. 5A is a schematic view showing a power control circuit in accordance with another preferred embodiment of the present invention applied in a buck power converter; and

FIG. 6 is a flow chart showing a method of compensating a voltage drop on a power wire in accordance with a preferred embodiment of the present invention.

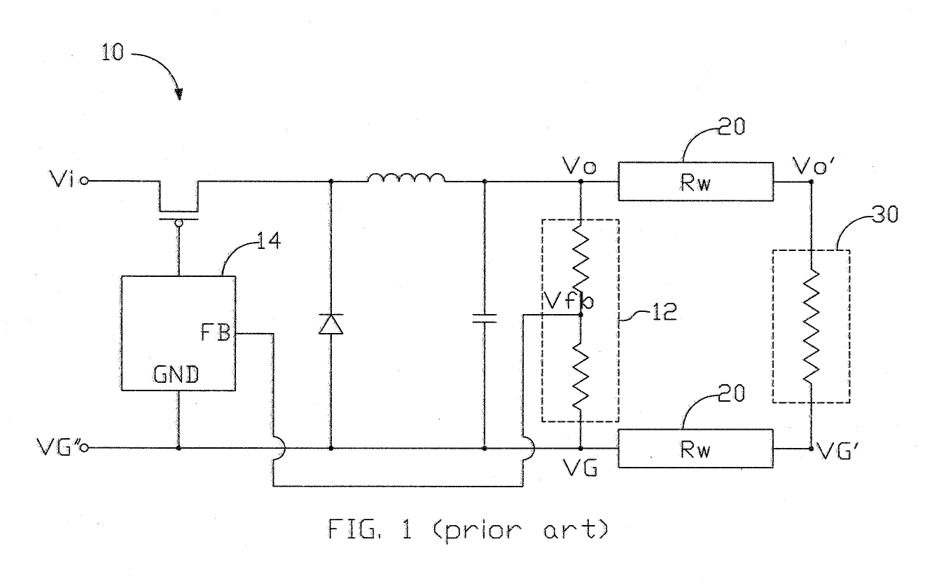

### DESCRIPTION OF THE PREFERRED EMBODIMENT

A main feature of the present invention is to couple a compensation resistor to the power wire for sensing the current on the power wire and use the compensation resistor to enhance the level of the feedback signal so as to compensation the voltage drop on the power wire.

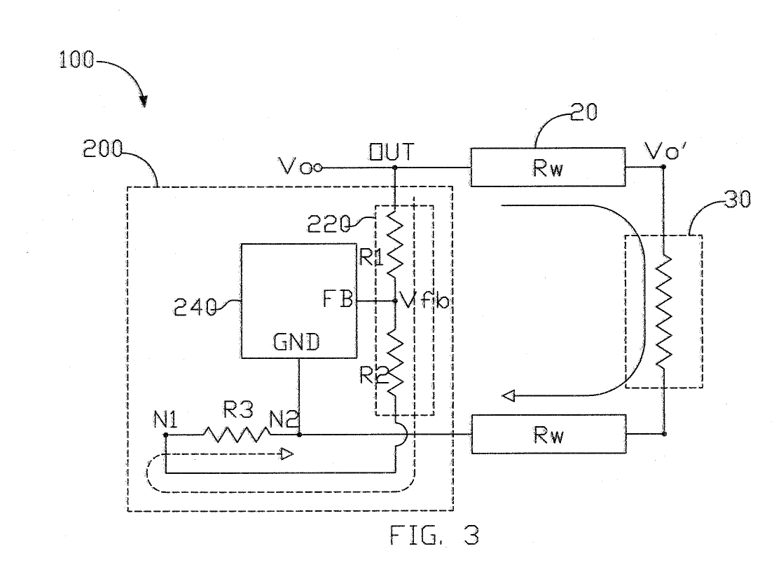

FIG. 3 is a schematic view showing a power control circuit 200 with the function of wire compensation in accordance with a preferred embodiment of the present invention. The power control circuit 200 is applied in a power converter 100 to control the output of the power converter 100. The output voltage Vo of the power converter 100 is supplied to a load 30 through a power wire 20.

As shown, the power control circuit 200 has a feedback circuit 220, a controller 240, and a compensation resistor R3. The feedback circuit 220 is utilized for detecting the output voltage Vo of the power converter 100 and generates a feedback signal Vfb accordingly. The controller 240, which may be formed on a chip, is utilized to control the conduction time of a switch (not shown) of the power controller 100 according to the feedback signal Vfb so as to stabilize the output voltage Vo.

The compensation resistor R3 has a first end N1 coupled to the feedback circuit 220 and a second end N2 coupled to the power wire 20. The compensation resistor R3 and the feedback circuit 220 compose a feedback loop as indicated by the dashed arrow. Meanwhile, the compensation resistor R3 and the power wire 20 compose a power loop as indicated by the solid arrow. In addition, the controller 240 has a grounded end GND coupled to a terminal of the feedback loop, and the grounded end GND also connected to a node on the power loop between the compensation resistor R3 and the power wire 20. Thereby, the compensation resistor R3 is able to detect (or access) the current on the power wire 20 and enhance the level of the feedback signal Vfb according to the detected current. The object of wire compensation is thus fulfilled.

The feedback circuit 220 may be any circuit capable of transforming the output voltage Vo into a feedback signal Vfb with a level proportional to that of the output voltage Vo. A voltage-dividing circuit 220 is provided in the present embodiment as an example. As shown, the voltage-dividing circuit 220 has a high level end coupled to a power supply end OUT at the output of the power converter 100, a low level end coupled to the compensation resistor R3, and an output end coupled to the controller 240 to output the feedback signal Vfb. In the present embodiment, the voltage-dividing circuit 220 is composed of a first resistor R1 and a second resistor R2. The first resistor R1 has one end coupled to the power supply end OUT at the output of the power converter 100 and the other end connected to the second resistor R2. A junction between the first resistor R1 and the second resistor R2 is utilized to output the feedback signal Vfb. The compensation resistor R3 is serially connected to the second resistor R2 to enhance the level of the feedback signal Vfb.

The power control circuit 200 in the above mentioned embodiment may adapted in any kind of power converters with feedback control, such as the buck power converter, the boost power converter, the flyback power converter, and etc. For a better understanding of the present invention, a buck power converter is described below as an example.

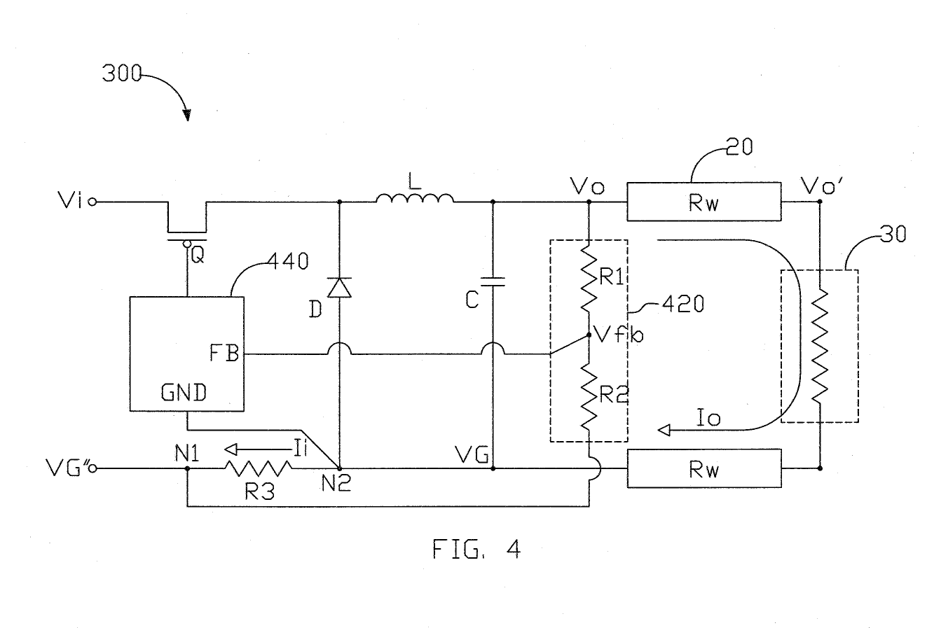

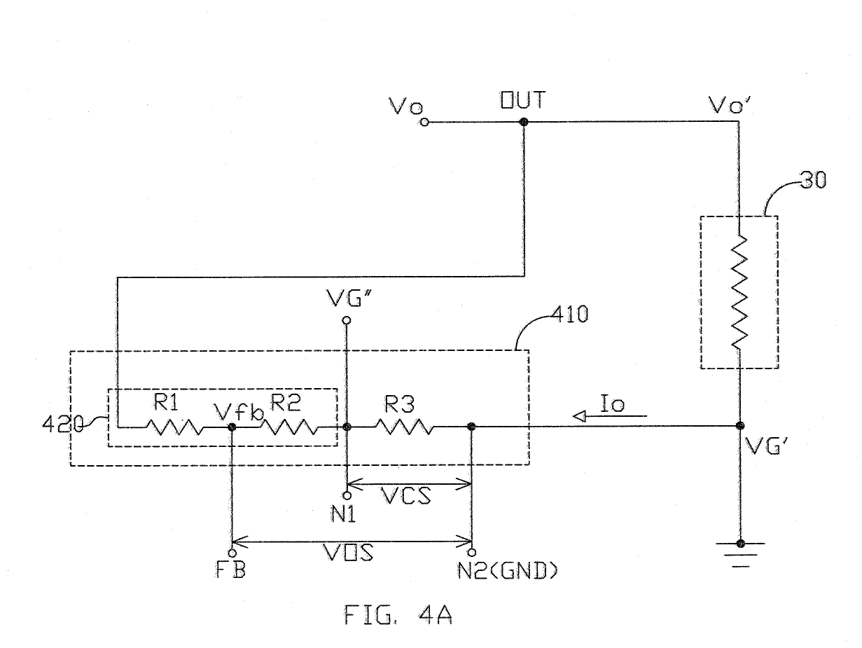

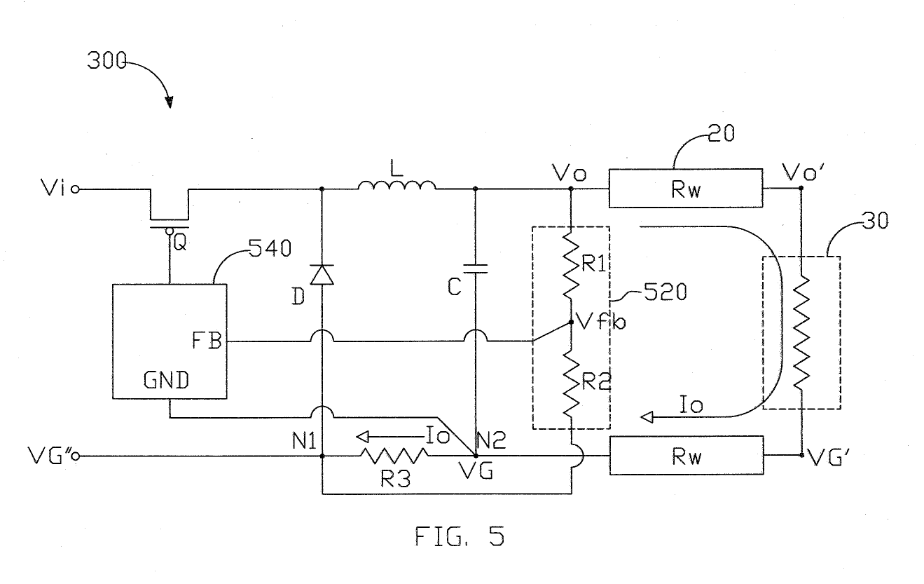

FIG. 4 is a schematic view showing a power control circuit in accordance with a preferred embodiment of the present invention adapted in a buck power converter 300. As shown, the buck power converter 300 has a switch Q, an inductor L, a capacitor C, and a diode D. When the level of output voltage Vo is lower than a preset voltage level, the switch Q is conducted to generate a current charging the capacitor C so as to increase the level of the output voltage Vo. Then, as the output voltage reaching the preset voltage level, the switch Q is turned off and a current is generated on the loop composed of the capacitor C, the diode D, and the inductor L.

The feedback circuit 420 has a first resistor R1 and a second resistor R2. The first resistor R1 is serially connected to the second resistor R2 to compose a voltage-dividing circuit which has a high level end electrically connected a power supply end OUT at the output of the power converter 300 and a low level end electrically connected to the compensation resistor R3. In addition, the junction between the first resistor R1 and the second resistor R2 outputs the feedback signal Vfb.

The compensation resistor R3 has a first end N1 coupled to the second resistor R2 and a second end N2 coupled to a grounded end GND of the controller 440. Therefore, for the feedback loop composed of the voltage-dividing circuit 420 and the compensation resistor R3, the voltage drop across the compensation resistor R3 may be utilized to enhance the level of the feedback signal Vfb.

Moreover, the second end N2 of the compensation resistor R3 is also coupled to the power wire 20, and the first end N1 of the compensation resistor R3 is also coupled to a grounded end VG″ at the input of the power converter 300. Thus, there is an input current Ii flowing through the compensation resistor R3, which is proportional to the current Io on the power wire 20. That is, the voltage drop across the compensation resistor R3 would be proportional to the voltage drop on the power wire 20.

In the present embodiment, the second end N2 of the compensation resistor R3 is coupled to the positive end of the diode D to access the input current Ii of the power converter 300. Since the input current Ii is proportional to the current Io on the power wire 20, the current Io on the power wire 20 can be detected by using the compensation resistor R3. In addition, the feedback signal Vfb outputted from the feedback circuit 420 is relative to the voltage drop across the compensation resistor R3. Accordingly, the level of the feedback signal Vfb generated by the feedback circuit 420 can be enhanced to compensate the voltage drop on the power wire 20 according to the output current Io detected by the compensation resistor R3.

For a better understanding of how the feedback signal Vfb is enhanced, referring to FIG. 4A, the feedback circuit 420 and the compensation resistor R3 composes an adaptive sensing circuit 410, which detects the output voltage Vo of the power converter 300 and the current Io on the power wire 20 and generates the feedback signal Vfb according to the output voltage Vo and the current Io on the power wire 20. The adaptive sensing circuit 410 has a first resistor R1, a second resistor R2, and the compensation resistor R3. The three resistors R1, R2, and R3 are connected in a string. The resistor string has one end electrically coupled to a power supply end OUT at the output of the power converter 300 and the other end electrically coupled to a grounded end VG′ at the load 22 so as to form a circuit loop with the load 22. The grounded end VG′ at the load 22 and the grounded end VG,VG″ at the power converter 300 may be independent.

Also referring to FIG. 4, in case the input current Ii flowing through the compensation resistor R3, the current sensing signal VCS, which equals to the voltage drop crossing the compensation resistor R3, is proportional to the input current Ii as well as the current Io on the power wire 20, which can be computed by using the following function.

$$VCS = r 3 \times Ii = r 3 \times Io \times \frac{{Vo}^{′} - {Vg}^{′}}{Vi - {Vg}^{″}} \qquad ( 1 )$$

Wherein, r3 implies the resistance of the compensation resistor R3, Vo′ is the voltage level received by the load 22, Vi is the input voltage of the power converter 300, Vg″ is the voltage level of the grounded end VG″ at the input of the power converter circuit 20, and Vg′ is the voltage level of the grounded end VG′ at the load 22.

With the voltage dividing ability of the resistor string, voltage level of the voltage sensing signal VOS, which equals to the difference between the level of the feedback signal Vfb and that at the grounded end GND of the controller 440, shows a certain relationship with the load voltage Vo′ and the current Io on the power wire 20, which can be computed by using the following function.

$$( {Vo}^{′} - {Vg}^{′} ) = ( 1 + \frac{r 1}{r 2} ) \times VOS + ( \frac{r 1}{r 2} ) ( r 3 \times Io \times \frac{{Vo}^{′} - {Vg}^{′}}{Vi - {Vg}^{″}} ) \qquad ( 2 )$$

Wherein, r1 and r2 imply the resistance of the first resistor R1 and the second resistor R2, respectively.

According to the above mentioned functions (1) and (2), the voltage level of the feedback signal Vfb can be enhanced according to the voltage level of the current sensing signal VCS.

The above mentioned functions (1) and (2) are derived in case of the buck power converter 300. Such relationships among the voltage sensing signal VOS, the current sensing signal VCS, the load voltage Vo′, and the output current Io are also available in case of the boost power converter, the buck-boost power converter, and etc. Thus, the idea of the present invention is capable to be applied to power converters of different power conversion models.

In addition, as a preferred embodiment, the compensation resistor R3 may increase the output voltage Vo with an amount V1 to compensate the actual voltage Vo′ supplied to the load 30, wherein V1=(R1/R2)*Ii*R3. Thus, to fully compensate the voltage drop due to the parasitic resistor 2*Rw on the power wire 20, the resistance of the compensation resistor R3 can be determined by using the following function: R3=2*(R2/R1)*Rw*(Vi/Vo).

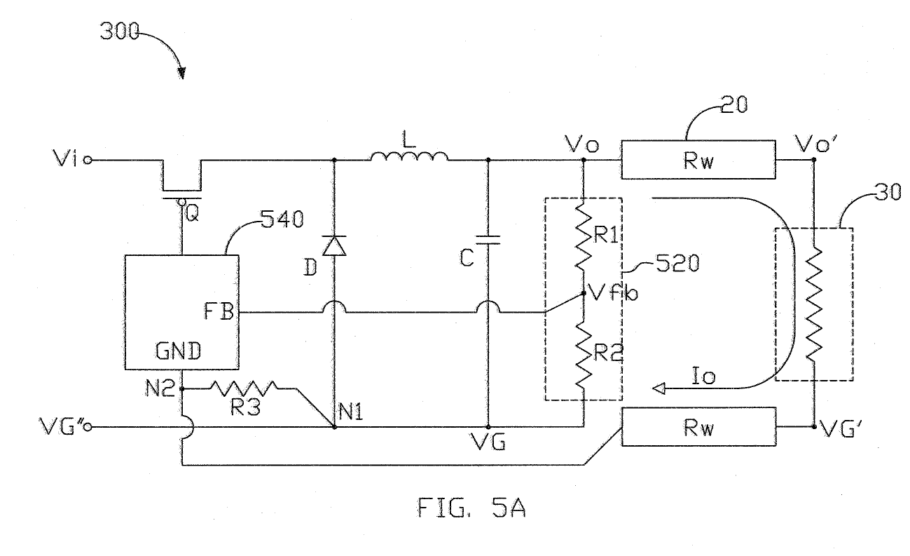

FIG. 5 is a schematic view showing a power control circuit in accordance with another preferred embodiment of the present invention adapted in a buck power converter 300. In contrast with the embodiment of FIG. 4, the compensation resistor R3 in the present embodiment has a first end N1 coupled to the diode D and a second end N2 coupled to the capacitor C to access the output current Io of the power converter 300.

Also referring to FIG. 4A, in the present embodiment, the output current to flows through the third compensation R3, the voltage level crossing the compensation resistor R3 is proportional to the output current Io, which can be computed by using the following function.

VCS=r3×Io (3)

Wherein, r3 implies the resistance value of the third resistor R3.

With the voltage dividing ability of the resistor string, voltage level of the voltage sensing signal VOS shows a certain relationship with the load voltage Vo′ and the load current Io, which can be computed by using the following function.

$$( {Vo}^{′} - {Vg}^{′} ) = ( 1 + \frac{r 1}{r 2} ) \times VOS + ( \frac{r 1}{r 2} ) ( r 3 \times Io ) \qquad ( 4 )$$

Wherein, r1 and r2 imply the resistance value of the first resistor R1 and the second resistor R2, respectively.

According to the above mentioned functions (3) and (4), the voltage level of the feedback signal Vfb can be enhanced according to the voltage level of the current sensing signal VCS.

The compensation resistor R3 in the present embodiment may increase the output voltage Vo with an amount V2 to compensate the actual voltage Vo′ supplied to the load 30, wherein V2=(R1/R2)*Io*R3. Thus, to fully compensate the voltage drop due to the parasitic resistor 2*Rw on the power wire 20, the resistance of the compensation resistor R3 can be determined by using the following function: R3=2*(R2/R1)*Rw.

FIG. 5A is a schematic view showing a power control circuit in accordance with still another preferred embodiment of the present invention adapted in a buck power converter 300. In contrast with the embodiment as shown in FIG. 5, the compensation resistor R3 of the present embodiment has a first end N1 coupled to the diode D and has a second end N2 coupled to the power wire 20 as well as the grounded end GND of the controller 540 to access the output current Io of the power converter 300 but not coupled to the capacitor C. The relationship between the resistance of the compensation resistor R3 and that of the power wire 20 is identical to the embodiment as shown in FIG. 5.

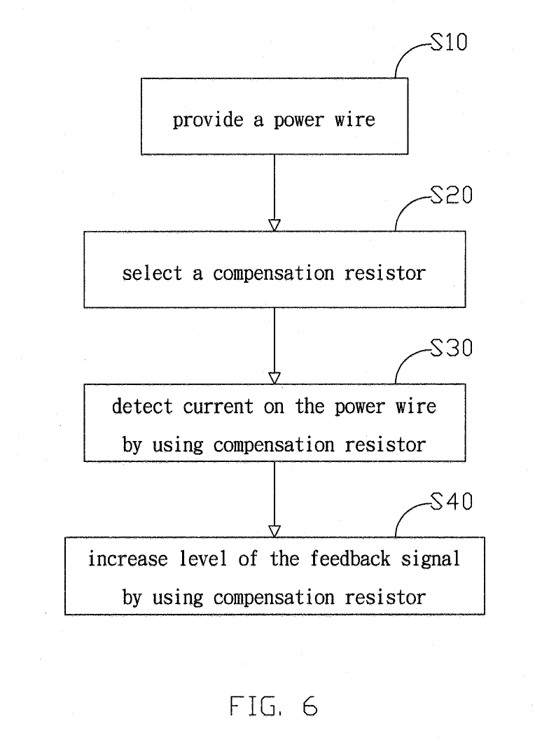

FIG. 6 is a flow chart showing a method for compensating the voltage drop on the power wire according to an embodiment of the present invention. Also referring to FIG. 3, firstly, as indicated in step S10, the power wire 20 for connecting the power converter to the load 30 is provided. Then, as indicated in step S20, a compensation resistor R3 is selected according to a resistance of the power wire 20. As mentioned above, the relationship between the resistance of the compensation resistor R3 and that of the power wire Rw is decided according to the parameters within the power converter 300. The resistance of the compensation resistor R3 should be proportional to that of the power wire 20. Thereafter, as indicated in step S30, the compensation resistor R3 is electrically connected to the power wire 20 for detecting the current Io on the power wire 20. Then, the compensation resistor R3 is electrically connected to a feedback circuit 220 of the power converter 100 to enhance the level of the feedback signal Vfb outputted from the feedback circuit 220.

Also referring to FIGS. 4 and 5, the compensation resistor R3 can be used to detect the output current Io or the input current Ii through adjusting the electric elements to which the compensation resistor R3 is connected, and both the output current Io and the input current Ii of the power converter 300 can be used for compensating the voltage drop on the power wire 20. That is, as the compensation resistor R3 is coupled to the grounded end VG at the output of the power converter 300, the compensation resistor R3 may be utilized to detect the output current Io of the power converter 300. As the compensation resistor R3 is coupled to the grounded end VG″ at the input of the power converter 300, the compensation resistor R3 may be utilized to detect the input current Ii of the power converter 300.

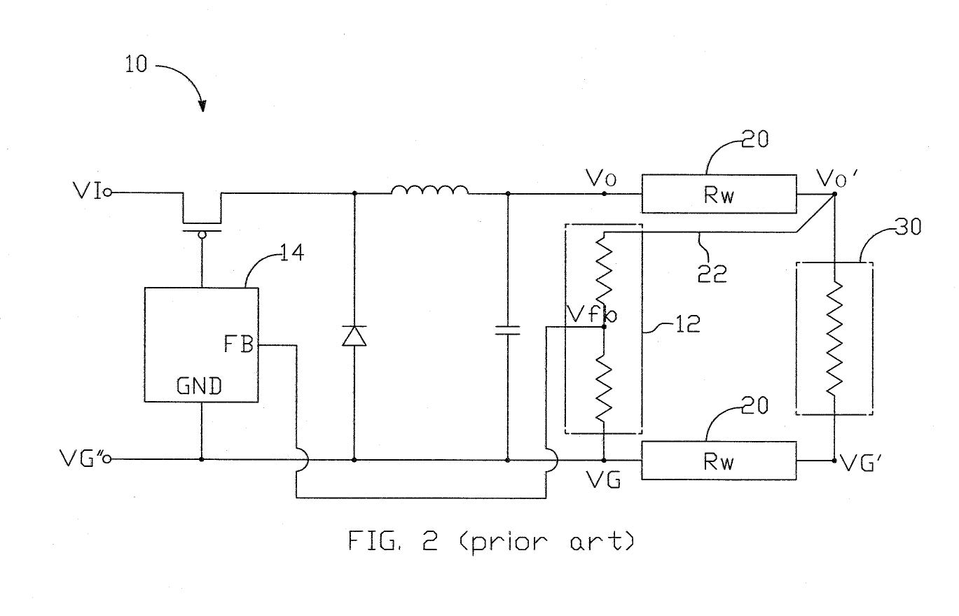

Referring to FIG. 2, in order to compensate the voltage drop on the power wire 20, the typical method uses at least a detecting wire connected to the load 30 for sensing the actual voltage transmitted to the load 30 and the equipment cost is thus increased. In addition, as the power supplying distance increases, the cost of the detecting wire 22 would be more significant. In contrast, as shown in FIG. 3, there only needs a compensation resistor R3 in the power control circuit 200 of the present invention for compensating the voltage drop on the power wire 20. The compensation resistor R3 is assembled in the power converter and does not have to connect the remote load 30. Thus, the equipment cost can be effectively reduced.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A power control circuit for wire compensation, which is adapted in a power converter having an output coupled to a load through a power wire, the power control circuit comprising:
an adaptive sensing circuit, utilized for detecting an output voltage of the power converter and a current on the power wire, and generating a feedback signal according to the output voltage and the current on the power wire; and
a controller, adjusting a level of the output voltage according to the feedback signal.

2. The power control circuit of claim 1, wherein the adaptive sensing circuit comprises:
a feedback circuit, utilized for detecting the output voltage of the power converter to generate the feedback signal; and
a compensation resistor, coupled to the power wire for detecting the current on the power wire, and coupled to the feedback circuit for increasing a level of the feedback signal according to the current on the power wire.

3. The power control circuit of claim 2, wherein a resistance of the compensation resistor has a predetermined relationship to that of the power wire show.

4. The power control circuit of claim 2, wherein a first end of the compensation resistor is coupled to the feedback circuit and a second end of the compensation resistor is coupled to the power wire.

5. The power control circuit of claim 2, wherein the feedback circuit has a high level end coupled to a power supply end at the output of the power converter, a low level end coupled to a grounded end at an input of the power converter and the compensation resistor, and a output end for outputting the feedback signal.

6. The power control circuit of claim 4, wherein the second end of the compensation resistor is coupled to a grounded end of the controller.

7. The power control circuit of claim 6, wherein the compensation resistor is coupled to a grounded end at the output of the power converter for accessing an output current of the power converter.

8. The power control circuit of claim 6, wherein the compensation resistor is coupled to a grounded end at an input of the power converter for accessing an input current of the power converter.

9. The power control circuit of claim 2, wherein the feedback circuit and the compensation resistor composes a feedback loop, the power wire and the compensation resistor composes a power loop, a grounded end of the controller is coupled to a terminal of the feedback loop and a node on the power loop between the compensation resistor and the power wire.

10. The power control circuit of claim 1, wherein the adaptive sensing circuit is utilized for detecting the output current of the power converter to generate the feedback signal accordingly.

11. The power control circuit of claim 1, wherein the adaptive sensing circuit is utilized for detecting the input current of the power converter to generate the feedback signal accordingly.

12. The power control circuit of claim 1, wherein the adaptive sensing circuit is a voltage dividing circuit.

13. A method for compensating a voltage drop on a power wire comprising the steps of:
providing the power wire, which is utilized for transmitting power from a power converter to a remote load;
selecting a compensation resistor according to a resistance of the power wire;
electrically connecting the compensation resistor to the power wire; and
electrically connecting the compensation resistor to a feedback circuit of the power converter to increase a level of a feedback signal outputted from the feedback circuit.

14. The method for compensating a voltage drop on a power wire of claim 13, wherein the compensation resistor is utilized for detecting an input current or an output current of the power converter.

15. The method for compensating a voltage drop on a power wire of claim 14, wherein the compensation resistor is electrically connected to a grounded end at an output of the power converter for detecting the output current.

16. The method for compensating a voltage drop on a power wire of claim 14, wherein the compensation resistor is coupled to a grounded end at an input of the power converter for detecting the input current.

17. The method for compensating a voltage drop on a power wire of claim 13, wherein a relationship between a resistance of the compensation resistor and that of the power wire is decided according to the power converter.
